(19) United States
(12) Patent Application Publication
(10) Pub. No.: US 2006/0123473 A1
(43) Pub. Date: Jun. 8, 2006

(54) TWO-WAY COMMUNICATION DEVICE CAPABLE OF COMMUNICATING THROUGH A FIREWALL

(76) Inventors: Cheng-Su Huang, Taipei City (TW); Bing-Fei Wu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/904,972

(22) Filed: Dec. 7, 2004

(51) Int. Cl. G06F 15/16

(52) U.S. Cl. 726/11

(57) ABSTRACT

A two-way communication device capable of communicating through a firewall includes a network module capable of exchanging signals through a network line, and a control module capable of receiving a terminal connecting condition of a client through a public switched telephone network (PSTN) line for controlling the network module to exchange signals with the client through the network line according to the terminal connecting condition.

### BACKGROUND OF INVENTION

1. Field of the Invention

The present invention provides a two-way communication device, and more particularly, a two-way communication device capable of communicating through a firewall.

2. Description of the Prior Art

In prior art network communication, a server often provides network service with a firewall for preventing unauthorized clients from accessing the server, so as to maintain the safety of the data flow. One terminal of the firewall connects to the Internet (through a real IP), and the other connects to an intranet of the server (through a virtual IP) for isolating Internet and the intranet. Therefore, the firewall is the only channel for entering the intranet, and data exchanges pass a check of the firewall, which increases safety.

In general, data should pass a confirmation of the firewall both from Internet to the intranet and from the intranet to Internet. The confirmation is set initially according to safety rules or policies, which can be changed by a manager of the firewall according to the degree of risk felt by the manager.

Therefore, the confirmation of the firewall checks a user's authorization, so as to block a user without authentication from attacking the server (such as transmitting a larger number of packages or viruses, which consume a large bandwidth, and cause heavy loads). However, the firewall also prevents common users from uploading to the server, causing disadvantages of common operations in two-way communication, such as exchanging and monitoring real-time images.

### SUMMARY OF INVENTION

It is therefore a primary objective of the claimed invention to provide a two-way communication device.

According to the claimed invention, a two-way communication device capable of communicating through a firewall includes a network module capable of exchanging signals through a network line, and a control module capable of receiving a terminal connecting condition of a client through a public switched telephone network (PSTN) line for controlling the network module to exchange signals with the client through the network line according to the terminal connecting condition.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a schematic diagram of a communication system having two-way communication devices in accordance with the present invention.

FIG. 2 illustrates a schematic diagram of the two-way communication devices in FIG. 1 having video modules.

FIG. 3 and FIG. 4 illustrate schematic diagrams of communication systems having two-way communication devices in accordance with the present invention.

### DETAILED DESCRIPTION

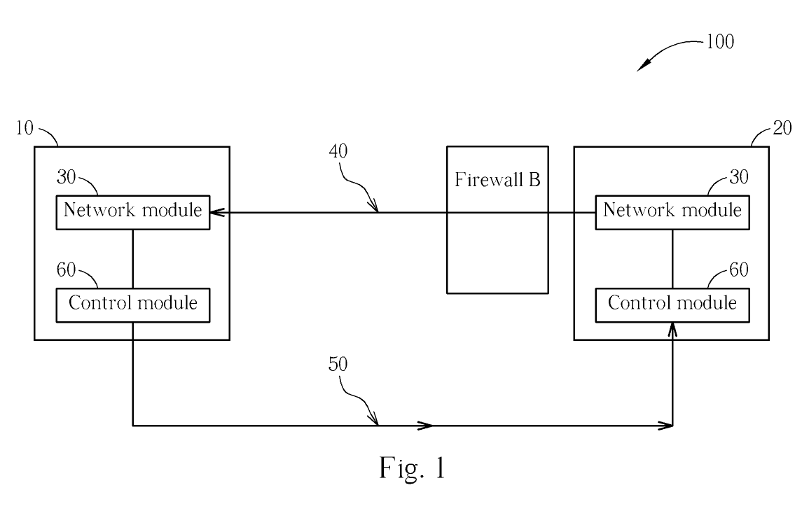

Please refer to FIG. 1, which illustrates a schematic diagram of a communication system 100 having two-way communication devices 10 and 20 in accordance with the present invention. Both of the two-way communication devices 10 and 20 include network modules 30 and control modules 60, which can be seen as a web phone combined with a conventional phone. The network modules 30 exchange signals through a network line 40 of the communication system 100, while the control modules 60 exchange signals through a PSTN (public switched telephone network) line 50 of the communication system 100. As shown in FIG. 1, a firewall B is set before the two-way communication device 20, which can block signals from specific ports. That is, only if the two-way communication device 10 comprehends which ports of the firewall B are accessible can the two-way communication device 10 transmit data or signals to the two-way communication device 20 through the network line 30.

As to operations of the communication system 100, please refer to following example. No matter if the two-way communication 10 comprehends the accessible ports of the firewall B or not, after the two-way communication device 10 dials a phone number of the two-way communication device 20, the two-way communication device 10 transmits a local connecting condition to the two-way communication device 20. The local connecting condition describes a real IP (Internet Protocol) address and accessible ports of the two-way communication device 10. From the point of view of the two-way communication device 20, the local connecting condition of the two-way communication device 10 can be seen as a terminal connecting condition; that is, the terminal connecting condition describes which ports and what IP address of the two-way communication device 10 can be accessed. After receiving the terminal connecting condition, the two-way communication device 20 starts to exchange signals (such as video signals, voice signals, etc.) through the network line 40 with the network module 30 according to the accessible ports and the IP address of the two-way communication device 10 described in the terminal connecting condition. In this way, the two-way communication device 10 comprehends the accessible ports and the real IP address of the two-way communication device 20, and a network connection is built between the network modules 30 of the two-way communication device 10 and 20 through the network line 40.

In short, considering safety, the firewall B allows signals from accessible ports, but blocks those from the other ports. However, the two-way communication device 10 does not comprehend the exact accessible ports of the two-way communication device 20 initially, so the two-way communication device 10 requests a network connection through the PSTN line 50. Meanwhile, the two-way communication device 10 transmits information of the real IP address and the accessible ports of the two-way communication device 10 to the two-way communication device 20, ensuring that the two-way communication device 20 can build the network connection that can communicate through the firewall B according to the real IP address and the accessible ports of the two-way communication device 10. As a result, the network connection between the two-way communication device 10 and 20 is built through the firewall B.

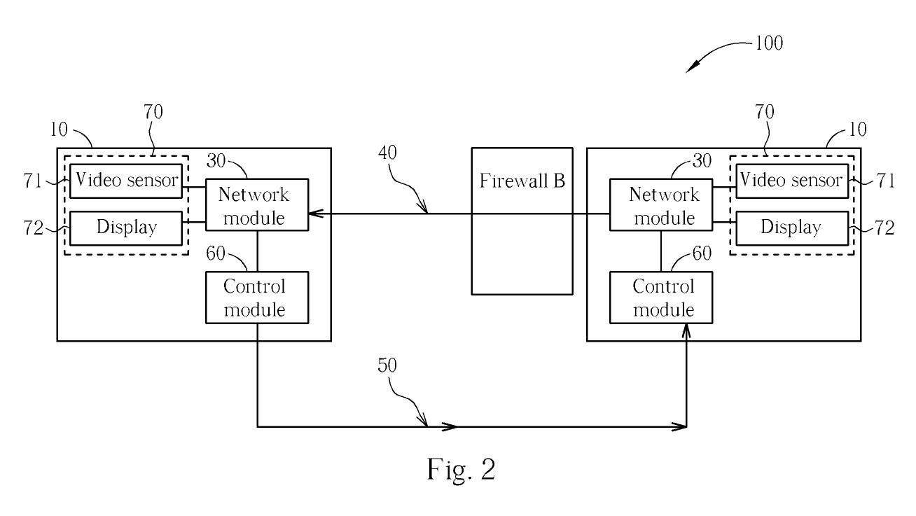

As those skilled in the art recognize, the network line 40 has a broader bandwidth than the PSTN line 50, so it is possible for the present invention two-way communication device to exchange real-time video or digital data. Please refer to FIG. 2, which illustrates a schematic diagram of the communication system 100 when the two-way communication devices 10 and 20 have video modules 70. The video module 70 includes a video sensor 71 and a display 72. The video sensor 71 can be a CCD (charge coupled device) or a complementary metal oxide semiconductor camera, which can take a real-time video, while the display 72 can be a liquid crystal display (LCD), which can display a real-time video from the network module 30. Therefore, after a network connection is built, the two-way communication devices 10 and 20 in FIG. 2 can transmit and receive video signals with the video modules 70.

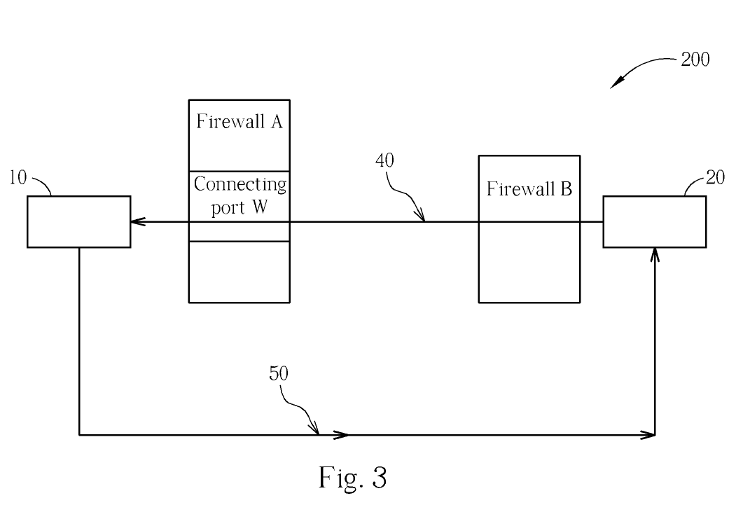

In addition, other than the communication system 100 in FIG. 1, which includes only the firewall B before the two-way communication device 20, please refer to FIG. 3, which illustrates a schematic diagram of the present invention two-way communication devices 10 and 20 in FIG. 1 used in a communication system 200 having another firewall A before the two-way communication device 10. If the firewall A includes an accessible connecting port W, all signals from other ports will be blocked. At first, the two-way communication device 10 does not comprehend which ports of the firewall B are accessible. Therefore, after dialing the phone number of the two-way communication device 20, the two-way communication device 10 transmits the information of its accessible ports W and real IP address to the two-way communication device 20. As a result, the two-way communication device 20 builds a network connection through the firewall B and through the accessible port W of the firewall A.

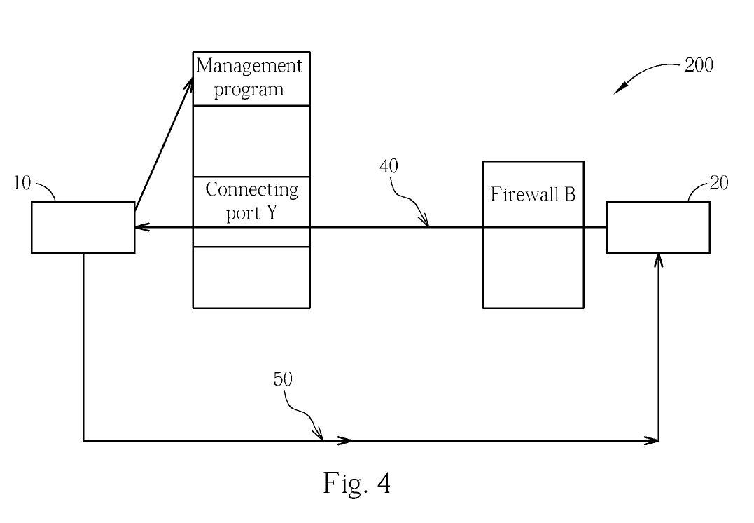

Moreover, in some cases, if the connection port W of the firewall A is not available (the network is too busy, or the port W is used for other applications for example), the present invention two-way communication device can instruct the firewall to open a port. Please refer to FIG. 4, which illustrates a schematic diagram of the two-way communication devices 10 in FIG. 3 instructing the firewall A to open a connecting port Y. When the present invention two-way communication device 10 detects that there is no available connecting port of the firewall A for the two-way communication device 20 to access, the two-way communication device 10 instructs the firewall A to open a connecting port Y with a management program. Then, the two-way communication device 10 transmits the information of the connection port Y and its real IP address to the two-way communication device 20, so as to build a network connection through the firewall B and the connecting port Y of the firewall A.

In summary, the present invention two-way communication device can pass through a firewall limitation, so as to exchange real-time video, voice, data, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A two-way communication device capable of communicating through a firewall, comprising:
a network module capable of exchanging signals through a network line; and
a control module capable of receiving a terminal connecting condition of a client through a public switched telephone network (PSTN) line for controlling the network module to exchange signals with the client through the network line according to the terminal connecting condition.

2. The two-way communication device of claim 1, wherein the terminal connecting condition comprises a description of a real IP (Internet Protocol) address and an accessible port of the client through a firewall.

3. The two-way communication device of claim 1, wherein the control module is capable of outputting a local connecting condition through a public switched telephone network (PSTN) line.

4. The two-way communication device of claim 3, wherein the local connecting condition comprises a description of a real IP (Internet Protocol) address and an accessible port of the two-way communication device through a firewall.

5. The two-way communication device of claim 1, further comprising a video sensor capable of taking a real-time video for the client through the network line with the network module.

6. The two-way communication device of claim 5, wherein the video sensor is a charge coupled device (CCD) camera.

7. The two-way communication device of claim 5, wherein the video sensor is a complementary metal oxide semiconductor (CMOS) camera.

8. The two-way communication device of claim 1, further comprising a display device capable of displaying a real-time video of the client through the network line with the network module.

9. The two-way communication device of claim 8, wherein the display device is a liquid crystal display (LCD).
